(19) United States
(12) Patent Application Publication
(10) Pub. No.: US 2016/0031498 A1
(43) Pub. Date: Feb. 4, 2016

(54) METHOD FOR REDUCING NOISE FROM AN IDLER WHEEL

(71) Applicant: Caterpillar Inc., Peoria, IL (US)

(72) Inventor: Eric Johannsen, Washington, IL (US)

(73) Assignee: Caterpillar Inc., Peoria, IL (US)

(21) Appl. No.: 14/884,813

(22) Filed: Oct. 16, 2015

(51) Int. Cl. B62D 55/096; B62D 55/14

(52) U.S. Cl. CPC B62D 55/0963; B62D 55/14

(57) ABSTRACT

A method of reducing noise on an idler wheel of a track type tractor is provided. The idler wheel includes a tread surface and a retaining surface on an outer periphery. The method includes machining the tread surface to a depth less than a predefined tolerance limit. The method further includes forming a metal mesh on the tread surface wherein the metal mesh is structured to define space between the tread surface and metal mesh to form a three dimensional structure. The method includes filling the space between the three dimensional structure and the tread surface with a noise reducing material to a predefined height.

### TECHNICAL FIELD

The present disclosure relates to an idler wheel of an endless track of a track type tractor and more particularly to a method of reducing noise from the idler wheel.

### BACKGROUND

Track type tractors have a track assembly that includes continuous tracks that form a loop around a drive wheel, and idler wheels. The continuous tracks have a plurality of track links that act as ground engaging members. The drive wheel, and idler wheels have an outer circumferential surface that are shaped such that the track links conform to the outer circumferential surface. The drive wheel transmits power from a power source to the continuous tracks. Typically, the idler wheel and the track links are made of metal. During the transmission of power the track links engage with the idler wheels and the metal to metal surface contact produces noise. Also, the contact between the idler wheel and the track shoes may cause excessive wear on these components and thus increase the maintenance cost of the track type tractor.

U.S. Publication Number 2005/253453 hereinafter referred as the '453 patent, describes a crawler-dozer having a track assembly that includes an idler wheel with an elastomeric ring extending around its outer surface. The ring is continuous and has no breaks in its periphery that permit it to fall off. The ring is not held onto the idler wheel by fasteners but by being force fit on or molded around the periphery of the idler wheel. The ring may be inhomogeneous, having different hardness or having reinforcing materials embedded in an elastomeric matrix. However, the '453 patent does not address relative motion between the tread ring and the track roller.

### SUMMARY OF THE DISCLOSURE

In one aspect of the present disclosure, a method of reducing noise from an idler wheel of a track type tractor is provided. The idler wheel includes a tread surface and a retaining surface on an outer periphery. The method includes machining the tread surface to a depth less than a predefined tolerance limit. The method further includes forming a metal mesh on the tread surface in which the metal mesh is structured to define space between the tread surface and metal mesh to form a three dimensional structure. The method includes filling the space between the three dimensional structure and the tread surface to a predefined height with a noise reducing material.

Other features and aspects of this disclosure will be apparent from the following description and the accompanying drawings.

### BRIEF DESCRIPTION OF THE DRAWINGS

FIG. 1 is a side view of a track-type tractor having an idler wheel with an endless track;

FIG. 2 is a partial sectional view of the idler wheel, along with a three dimensional structure according to an embodiment of the present disclosure;

FIG. 3 is a zoomed in partial sectional view of portion 3-3 in FIG. 2, showing the three dimensional structure along with the noise reducing material according to an embodiment of the present disclosure; and

FIG. 4 is a flow chart of a method for reducing the noise from the idler wheel according to an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

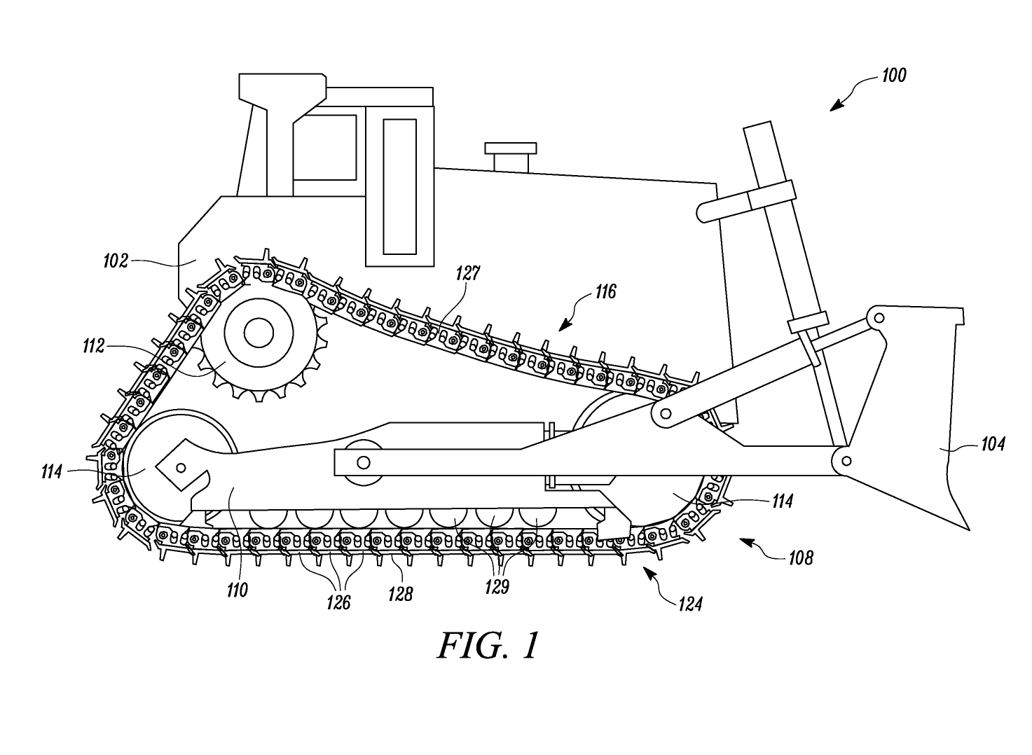

Referring now to FIG. 1, an exemplary machine 100 is embodied herein as a track-type tractor; however the present disclosure is not limited to track-type tractors and is applicable to other machines, such as, off highway trucks, skid steer machines, backhoe loaders, landfill compactors, shovels, excavators, motor graders, wheel loaders, and the like.

As illustrated in FIG. 1, the machine 100 includes a chassis or a frame 102, and a work implement 104. The machine 100 also includes a transmission system (not shown) and a propulsion system 108. In one embodiment, the machine 100 includes a power source(not shown), for example, a diesel engine, a gasoline engine, a gaseous fuel powered engine such as a natural gas engine, a combination of known sources of power or any other type of engine apparent to one of skill in the art. A transmission system (not shown) is communicably coupled to the power source. The transmission system includes coupling elements for transmitting a drive torque from the power source to the propulsion system 108.

The propulsion system 108 includes an undercarriage system 110 to propel the machine 100 over the ground. The undercarriage system 110 includes two separate continuous track link assemblies 124, one on either side of the machine 100 (only one of which is shown in FIG. 1). The track link assembly 124 includes components such as a number of track shoes 126, track links 127, pins, bushings, seals and thrust rings (not shown). The track shoes 126 can selectively engage a surface, e.g., the ground. The track shoes 126 includes a base portion (not shown) and a ground-engaging surface 128. The base portion of each of the track shoes 126 is coupled to each of the track links 127. The track links 127 are coupled by pins such that they form an endless chain. Each of the tracks links 127 are selectively coupled to one or more sprockets 112 that may drive the track shoes 126 via the track links 127. The track links 127 may be driven by the power source via the sprockets 112. The propulsion system 108 also includes two pairs of idler wheels 114 and rollers 129 that are rotatably secured to the undercarriage system 110.

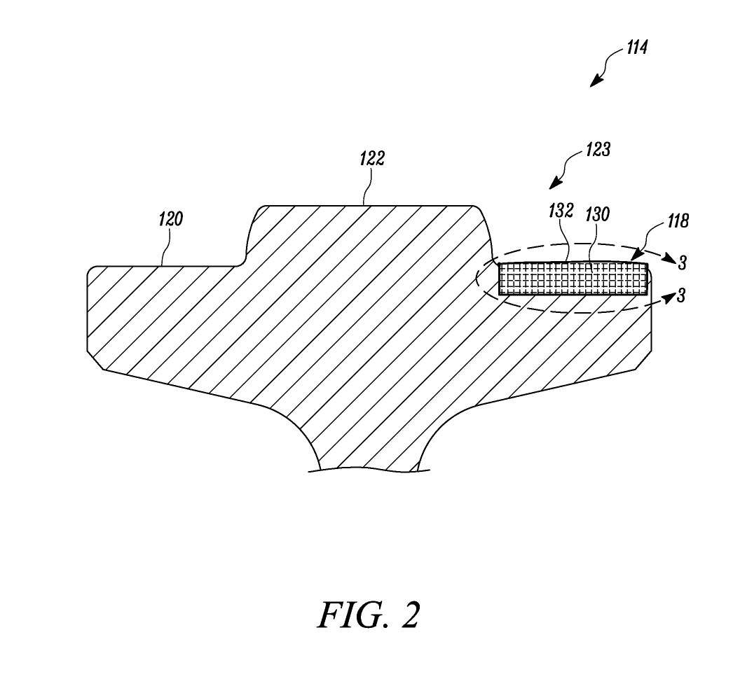

FIG. 2 is a partial sectional view of the idler wheel 114. The idler wheel 114 includes a tread surface 120 and a retaining surface 122 defined along an outer periphery 123 of the idler wheel 114. The retaining surface 122 extends circumferentially along a center portion of the outer periphery 123 of the idler wheel 114. The tread surface 120 extends on both sides of the retaining surface 122 of the idler wheel 114. During propulsion of the machine 100, the tread surface 120 and the retaining surface 122 conforms to the track links 127. Further, the tread surface 120 and the retaining surface 122 together guide the track link assembly 124 via track links 127. During transmission of power the track link assembly 124 propels the machine 100. The track links 127 engage with the idler wheel 114 and produce noise due to metal to metal contact.

In the present embodiment, the machine 100 includes one or more idler wheels 114 that produce less noise when engaging with the track links 127. Each of the idler wheels 114 includes the tread surface 120 that is machined to less than a predefined tolerance limit of the order of a few millimeters. The machining of the tread surface 120 may include grinding, honing, milling, turning, or a combination thereof. Further, the idler wheel 114 includes a metal mesh 130 that may be formed along the machined tread surface 120. The metal mesh 130 may be formed by three dimensional printing, rapid prototyping over the machined tread surface 120 or by welding, casting on the machined tread surface 120. The metal mesh 130 may be structured to define a space between the tread surface 120 and the metal mesh 130 that forms a three dimensional structure 118. The metal mesh 130 may have a predefined dimension, such as a metal strand having a thickness of about 0.5 to 0.7 millimeters. Similarly, the height of the metal mesh 130 may be of the order of 5 to 6 millimeters along the width of the tread surface 120.

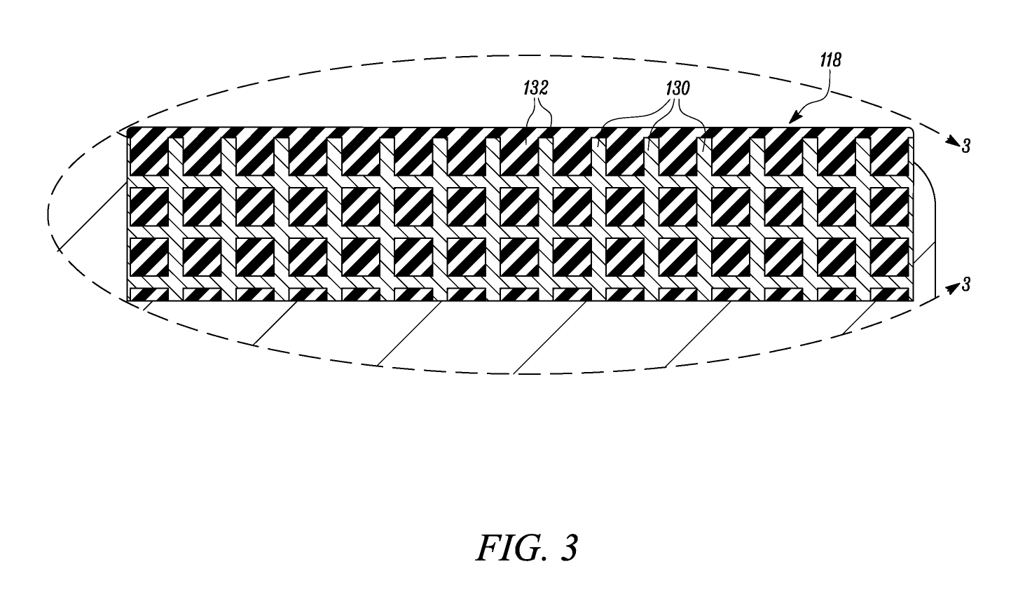

The space within and around the three dimensional structure 118 is filled or covered using a noise reducing material 132. FIG. 3 shows a sectional view of the three dimensional structure 118 filled with the noise reducing material 132. The noise reducing material 132 may be liquid natural or synthetic rubber or any viscoelastic material known in the art. The noise reducing material 132 may be poured into the metal mesh 130 to a predefined height. The predefined height of the noise reducing material 132 may cover the metal mesh 130. The noise reducing material 132 may then be cooled to set within and around the metal mesh 130.

### INDUSTRIAL APPLICABILITY

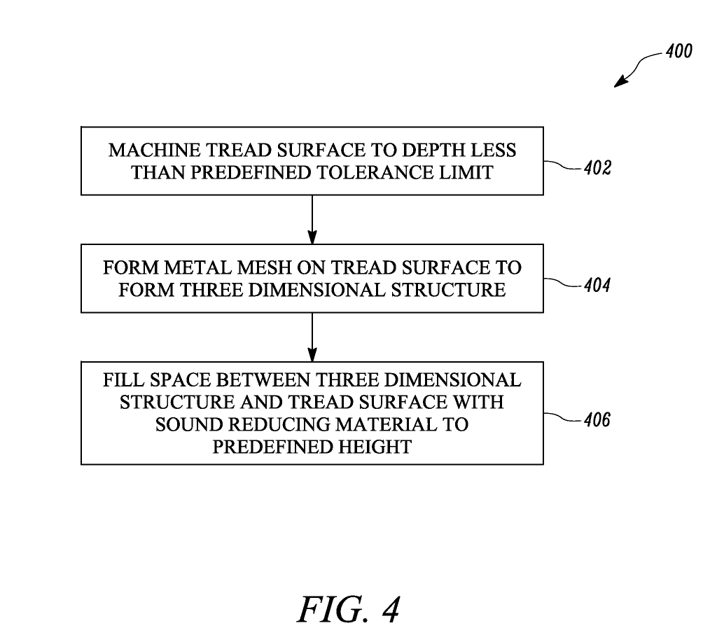

The present disclosure relates to a method 400 of reducing noise of the idler wheels 114. FIG. 4 is flow chart for the method 400 for reducing noise from the idler wheel 114. At step 402, the method 400 includes machining the tread surface 120 to a depth less than a predefined tolerance limit. At step 404, the method 400 includes forming the metal mesh 130 on the tread surface 120. Further, the metal mesh 130 is structured to define space between the tread surface 120 and the metal mesh 130 to form the three dimensional structure 118. At step 406, the method 400 includes filling the space between the three dimensional structure 118 and the tread surface 120 with the noise reducing material 132 to a predefined height.

The method 400 enables effective reduction in noise during the engagement between the track links 127 and the idler wheels 114, since there is less metal to metal contact between the idler wheels 114 and the track links 127. The metal mesh 130 also serves as a support for the noise reducing material 132. The metal mesh 130 further prevents any relative motion between the noise reducing material 132 and the tread surface 120, thereby increasing the work-life of the noise reducing material 132.

While aspects of the present disclosure have been particularly shown and described with reference to the embodiments above, it will be understood by one skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of reducing noise from an idler wheel of a track type tractor, the idler wheel comprising a tread surface and a retaining surface on an outer periphery, the method comprising:
machining the tread surface to a depth less than a predefined tolerance limit;
forming a metal mesh on the tread surface wherein the metal mesh is structured to define a space between the tread surface and the metal mesh to form a three dimensional structure; and
filling the space between the three dimensional structure and the tread surface with a noise reducing material to a predefined height.
